(19) United States
(12) Patent Application Publication
(10) Pub. No.: US 2017/0207445 A1
(43) Pub. Date: Jul. 20, 2017

(54) NONAQUEOUS ELECTROLYTE SECONDARY BATTERY

(71) Applicant: GS Yuasa International Ltd., Kyoto-shi, Kyoto (JP)

(72) Inventors: Hiroyuki KITAJIMA, Kyoto (JP); Toshiyuki AOKI, Kyoto (JP); Hiro FURIYA, Kyoto (JP); Hiroaki ENDO, Kyoto (JP)

(21) Appl. No.: 15/304,981

(22) PCT Filed: Apr. 16, 2015
(86) PCT No.: PCT/JP2015/002108

§ 371 Date: Oct. 18, 2016

(30) Foreign Application Priority Data
Apr. 25, 2014 (JP) 2014-092146

(51) Int. Cl. H01M 4/133; H01M 10/0587; H01M 10/0525; H01M 4/587; H01M 4/62

(52) U.S. Cl. CPC H01M 4/133; H01M 4/587; H01M 4/622; H01M 10/0525; H01M 10/0587; H01M 2004/027

(57) ABSTRACT

The present invention aims at improving both of power characteristics and a capacity retention ratio of a nonaqueous electrolyte secondary battery. A nonaqueous electrolyte secondary battery according to the present invention is characterized in that a negative electrode contains an aqueous binder as a binder and amorphous carbon as a negative active material, and an average particle size of the amorphous carbon is set to a specific average particle size, which is 7 μm or less. By employing a constitution of this characteristic, both of power characteristics and a capacity retention ratio of the nonaqueous electrolyte secondary battery can be improved.

### TECHNICAL FIELD

The present invention relates to a nonaqueous electrolyte secondary battery.

### BACKGROUND ART

In recent years, high performance batteries are positively being developed in association with downsizing and improvement in performance of electronic equipment such as cellular phones and mobile audio equipment, and a demand of a secondary battery capable of repeatedly using by charging is significantly increased. Particularly, a nonaqueous electrolyte secondary battery exhibiting high energy density and a high operating voltage, such as a lithium ion secondary battery, receives attention, and is widely used.

In such a nonaqueous electrolyte secondary battery, each electrode includes an active material supported on a current collector made of a conducting material as a main constituent. The positive electrode includes a positive active material supported on a positive current collector, and the negative electrode includes a negative active material supported on a negative current collector. In each electrode, a binder is used for binding the positive active materials or the negative active materials together.

Meanwhile, when high input/output characteristics are required in the nonaqueous electrolyte secondary battery, as described in Patent Document 1, amorphous carbon may be used as a part of the negative active material (refer to paragraph [0016] or the like). In this case, conventionally, solvent type binders typified by fluorine-based polymers such as polyvinylidene fluoride (PVdF) have been chiefly used as the binder for binding the amorphous carbons as a negative active material (refer to paragraph [0049] or the like).

### PRIOR ART DOCUMENT

### Patent Document

Patent Document 1: JP-A-2009-193924

### SUMMARY OF THE INVENTION

### Problems to be Solved by the Invention

In general, when an average particle size of an active material is reduced, power characteristics of a battery tend to increase. On the other hand, when the average particle size of an active material is reduced, an area of a reaction of the active material with the nonaqueous electrolyte increases in association with an increase in a specific surface area of the active material. This causes more decomposition reactions of a nonaqueous electrolyte, and thus there is a possibility of causing a problem that the capacity retention ratio of the battery is deteriorated. For example, the power characteristics are also improved by reducing the average particle size of the amorphous carbon when the amorphous carbon is used for the negative active material, but the capacity retention ratio can be deteriorated. Therefore, when the amorphous carbon is used for the negative active material, the average particle size of the amorphous carbon has been forced to be set to some large value in order to ensure the capacity retention ratio bearing a practical use. As a result of this, the battery is in a situation where setting of a particle size for ensuring a predetermined capacity retention ratio becomes a bottleneck and a significant improvement of power characteristics cannot be expected.

Thus, it is desired to improve both of power characteristics and a capacity retention ratio in the nonaqueous electrolyte secondary battery using amorphous carbon as the negative active material.

### Means for Solving the Problems

A constitution and the operation and effect of the present invention will be described including technological thought. However, an operating mechanism includes presumption, and its right and wrong does not limit the present invention. In addition, the present invention may be embodied in other various forms without departing from the spirit and main features. Therefore, embodiments and examples described later are merely exemplifications in all respects and are not to be construed to limit the scope of the invention. Moreover, variations and modifications belonging to an equivalent scope of the claims are all within the scope of the invention.

A first aspect of the present invention is a nonaqueous electrolyte secondary battery including a negative electrode including amorphous carbon as a negative active material and a binder, wherein the binder contains an aqueous binder, and wherein an average particle size of the amorphous carbon is 7 μm or less.

According to such a constitution, a nonaqueous electrolyte secondary battery having excellent power characteristics and an excellent capacity retention ratio can be provided.

That is, as described later, the present inventors made earnest investigations, and consequently found that in the battery including the negative electrode including the amorphous carbon as a negative active material, when an aqueous binder is used as a binder contained in the negative electrode, a surprising event occurs. The surprising event is unpredictable from conventional technical common knowledge. The event in which with a reduction of the average particle size of the amorphous carbon, power characteristics are improved, and the capacity retention ratio turns from decrease to increase at a specific average particle size as a boundary. It is distinct from the case of using a solvent type binder. Further, the present inventors found that the specific average particle size as the boundary exists within a range of about 10 to 20 μm.

That is, the nonaqueous electrolyte secondary battery according to the present invention is characterized by combining the negative electrode including an aqueous binder as a binder with the amorphous carbon having an average particle size of 7 μm or less which is smaller than the above specific average particle size as a negative active material, and by employing a constitution of this feature, power characteristics are improved, and a capacity retention ratio is improved contrary to conventional technical common knowledge. Particularly, the capacity retention ratio can be significantly improved comparing with the case in which the amorphous carbon as a negative active material is used in combination with the solvent type binder.

### Advantages of the Invention

According to the present invention, it is possible to provide a nonaqueous electrolyte secondary battery having excellent power characteristics and an excellent capacity retention ratio.

### BRIEF DESCRIPTION OF THE DRAWINGS

FIG. 1 is a schematic sectional view of an aspect of a nonaqueous electrolyte secondary battery of the present invention.

FIG. 2 is a schematic view showing an energy storage apparatus including the nonaqueous electrolyte secondary battery of the present invention.

FIG. 3 is a schematic view showing an automobile equipped with the energy storage apparatus including the nonaqueous electrolyte secondary battery of the present invention.

### MODE FOR CARRYING OUT THE INVENTION

In a second aspect of the present invention, the aqueous binder contains at least one selected from among rubber-like polymers and resin-based polymers which can be dissolved or dispersed in a water-based solvent in the nonaqueous electrolyte secondary battery according to the first aspect. When such a constitution is employed, it is preferred since power characteristics and a capacity retention ratio are more improved.

In a third aspect of the present invention, an interlayer distance d₀₀₂, which is determined by a wide angle X-ray diffraction method, of the amorphous carbon is 3.60 Å or more in the nonaqueous electrolyte secondary battery according to the first or second aspect. When such a constitution is employed, it is preferred since power characteristics are more improved.

In a fourth aspect of the present invention, the negative electrode includes a thickner, and wherein the thickner contains a cellulose-based polymer in the nonaqueous electrolyte secondary battery according to any one of the first to the third aspects.

In a fifth aspect of the present invention, the cellulose-based polymer includes a carboxymethyl cellulose in the nonaqueous electrolyte secondary battery according to the fourth aspect.

In a sixth aspect of the present invention, a degree of etherification of the cellulose-based polymer is 1 or less in the nonaqueous electrolyte secondary battery according to the fourth or fifth aspect.

A seventh aspect of the present invention is an assembled battery including a plurality of the nonaqueous electrolyte secondary batteries according to any one of the first to the sixth aspects.

An eighth aspect of the present invention is an energy storage apparatus including the assembled battery according to the seventh aspect.

A ninth aspect of the present invention is an automobile equipped with the energy storage apparatus according to the eighth aspect.

Embodiments of a nonaqueous electrolyte secondary battery according to the present invention will be described in reference to drawings. In the present embodiment, an example of applying the present invention to a lithium ion secondary battery in which lithium ions contained in the nonaqueous electrolyte play a role of electric conduction, will be described. Further, in the present embodiment, an example in which the present invention is applied to a prismatic lithium ion secondary battery will be described. In addition, in the following description, an explanation about an operating mechanism includes presumption, and its right and wrong does not limit the present invention.

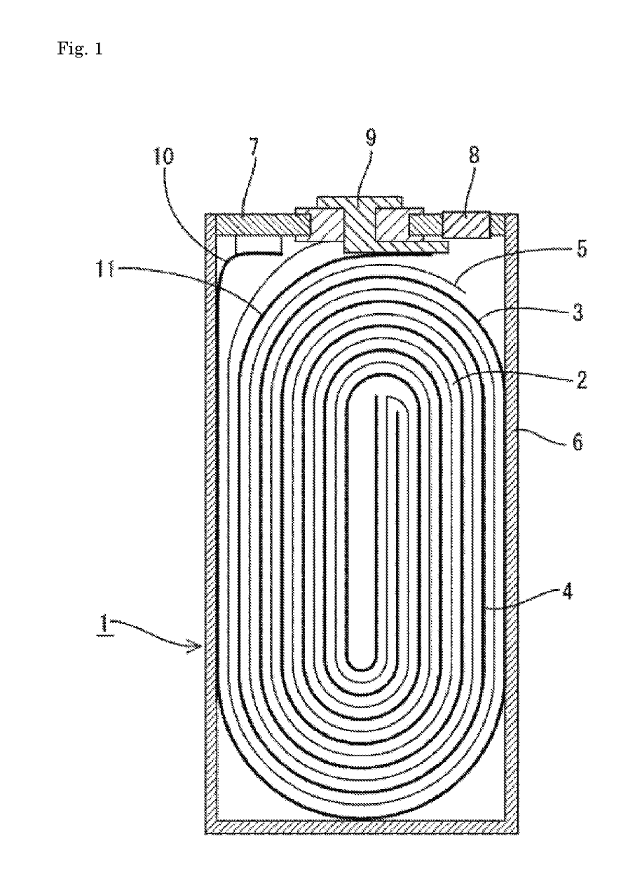

As shown in FIG. 1, a nonaqueous electrolyte secondary battery 1 includes a power generating element 2, a nonaqueous electrolyte (not shown) and a battery case 6 housing these. The power generating element 2 is an element functions as the core for discharge and charge, and is formed by including a positive electrode 3, a negative electrode 4 and a separator 5. In the present embodiment, the power generating element 2 is configured by winding the positive electrode 3 and the negative electrode 4 with the separator 5 interposed.

The negative electrode 4 includes a negative current collector and a negative composite layer formed on the negative current collector. The negative composite layer can contain a negative active material and a binder. The negative composite layer may contain a conduction aid as required. The negative composite layer can be formed by applying a negative composite (negative electrode paste) prepared by mixing these materials using, for example, a proper solvent appropriate to properties of the binder to the negative current collector, and drying the composite. In so doing, a thickness or a porosity of the layer can be adjusted by roll pressing.

The negative current collector is configured by using a conducting material. The negative current collector can be formed by using a metal material such as copper, nickel, stainless steel, or Ni electroplated steel. Further, as a shape of the negative current collector, various shapes such as a sheet (foil or thin film), a plate, a columnar body, a coil, a foam, a porous body and an expanded grid, can be employed.

The negative active material is not particularly limited with limits of capability of reversibly absorbing/releasing lithium ions. Examples of the negative active material include metallic lithium; lithium titanate such as Li₄Ti₅O₁₂; graphite; and amorphous carbons such as soft carbon (easily graphitizable carbon) and hard carbon (non-graphitizable carbon). In the present invention, the negative active material includes amorphous carbon in order to realize the nonaqueous electrolyte secondary battery 1 having high input/output characteristics.

Each carbon material can be identified by a value of an interlayer distance d₀₀₂ determined by a wide angle X-ray diffraction method. The amorphous carbon in the present invention is a carbon material whose interlayer distance d₀₀₂ is 3.40 Å or more. The interlayer distance d₀₀₂ is preferably 3.40 Å or more and 3.90 Å or less.

Further, in the amorphous carbon as the negative active material, a carbon net plane becomes smaller and a lamination of the plane becomes disordered as the interlayer distance d₀₀₂ increases exceeding 3.40 Å.

Thereby, insertion/extraction of lithium ions between layers becomes easy, leading to an improvement of power characteristics of a battery. Therefore, the interlayer distance d₀₀₂ of the amorphous carbon as the negative active material is more preferably 3.60 Å or more and 3.90 Å or less.

The amorphous carbon as the negative active material of the present invention has an average particle size of 7 μm or less. When the average particle size of the amorphous carbon is more than 7 μm and excessively large, there is a possibility that the difficulty in ensuring sufficient power characteristics may arise in practical use. Therefore, it is possible to adequately secure practicality by setting the average particle size of the amorphous carbon to 7 μm or less.

In addition, when the average particle size of the amorphous carbon is less than 2 μm and excessively small, there is a possibility that availability of a material is deteriorated and cost increases.

The average particle size of the amorphous carbon is not particularly limited with a limit of 7 μm or less; however, the average particle size is preferably 6 μm or less, more preferably 5 μm or less, furthermore preferably 4.5 μm or less, and moreover preferably 4 μm or less. Further, the average particle size of the amorphous carbon is preferably 0.5 μm or more, more preferably 1 μm or more, furthermore preferably 1.5 μm or more, and moreover preferably 2 μm or more.

The average particle size of the amorphous carbon is a particle size at which a cumulative percentage in a particle size distribution on a volumetric basis is 50% (D50). Specifically, a laser diffraction particle size distribution analyzer (SALD 2200, manufactured by Shimadzu Corporation) is used as a measurement apparatus, and Wing SALD 2200 is used as a measurement control software program. As a specific measurement technique, a measurement mode of scattering type is employed, and a wet cell, through which a dispersion with a measurement object sample (amorphous carbon) dispersed in a dispersive solvent is circulated, is irradiated with laser light to obtain a distribution of scattered light from the measurement sample. Then, the distribution of scattered light is approximated by a logarithmic normal distribution, and a particle size which corresponds to a degree of cumulative volume of 50% (D50) is taken as an average particle size. Further, it was verified that a particle size at which the cumulative percentage in the particle size distribution on a volumetric basis is 50% (D50) almost agrees with a particle size which is obtained by extracting 100 amorphous carbon particles from a SEM image of a plate. In measuring the extracted amorphous carbon particles, extremely large amorphous carbon particles and extremely small amorphous carbon particles should be avoided.

The conduction aid is a material to be added for the purpose of improving electrical conductivity of the negative composite layer, as required. As such a conduction aid, various conducting materials can be used. Examples of the conducting materials include carbon materials such as acetylene black, carbon black and graphite; conductive fibers such as metal fibers; metal (copper, nickel, aluminum, and silver) powders; conductive whiskers of zinc oxide or potassium titanate; and conductive metal oxides such as titanium oxide.

The binder (negative electrode binder) is a material to be contained for the purpose of binding the negative active materials together. Further, the binder also plays a role of binding the negative active material to the negative current collector. When the conduction aid is contained in the negative composite layer, the binder plays a role of binding the negative active material, the negative current collector and the conduction aid together. As such binders, in general, a solvent type binder for which an organic solvent is used when being mixed with an active material to form a paste, and an aqueous binder for which a water-based solvent (typically, water) can be used as a solvent, are present. In the present invention, the aqueous binder is used as the binder contained in the negative composite layer.

Further, when the solvent type binder is used as the binder, the solvent type binder is commonly dissolved in an organic solvent such as N-methyl-2-pyrrolidone for use in preparing a paste (composite) as the active material. Therefore, for example, in order to lessen the burden on the environment, it becomes necessary to recover the organic solvent as far as possible to reduce an amount of emission of the organic solvent. As a result of this, it takes much cost such as initial cost for equipment investment and operational cost for operating/controlling equipment.

When the aqueous binder is used as the binder contained in the negative composite layer like the present invention, it is unnecessary to recover the water-based solvent for forming a paste of the negative composite, and therefore it becomes possible to lessen the burden on the environment at low cost.

The aqueous binder is defined as a binder capable of using a water-based solvent in preparing a composite (electrode paste). More specifically, the aqueous binder is defined as a binder for which water or a mixed solvent predominantly composed of water can be used as a solvent in being mixed with an active material to form a paste. As such a binder, non-solvent type various polymers can be used.

As the aqueous binder contained in the negative composite layer, at least one selected from among rubber-like polymers and resin-based polymers which can be dissolved or dispersed in the water-based solvent, is preferably used. Herein, the water-based solvent refers to water or a mixed solvent predominantly composed of water. As a solvent, other than water, constituting the mixed solvent, organic solvents which can be uniformly mixed with water (lower alcohols, lower ketones, etc.), can be exemplified.

Examples of the rubber-like polymers which can be dissolved or dispersed in the water-based solvent include a styrene-butadiene rubber (SBR), an acrylonitrile-butadiene rubber (NBR), a methylmethacrylate-butadiene rubber (MBR), and the like. These polymers can be preferably used in a state of being dispersed in water as a binder. That is, examples of the aqueous binder which can be used include a water-dispersed matter of the styrene-butadiene rubber (SBR), a water-dispersed matter of the acrylonitrile-butadiene rubber (NBR), and a water-dispersed matter of the methylmethacrylate-butadiene rubber (MBR). Further, among these rubber-like polymers which can be dissolved or dispersed in the water-based solvent, the styrene-butadiene rubber (SBR) is preferably used.

Examples of the resin-based polymers which can be dissolved or dispersed in the water-based solvent include acrylic resins, olefinic resins, and fluorine-based resins. Examples of the acrylic resins include acrylic acid esters, methacrylic acid esters and the like. Examples of the olefinic resins include polypropylene (PP), polyethylene (PE) and the like. Examples of the fluorine-based resins include polytetrafluoroethylene (PTFE) and the like. These resins can be preferably used in a state of being dispersed in water as a binder. That is, examples of the aqueous binder which can be used include a water-dispersed matter of the acrylic acid ester, a water-dispersed matter of the methacrylic acid ester, a water-dispersed matter of the polypropylene (PP), a water-dispersed matter of the polyethylene (PE), and a water-dispersed matter of the polytetrafluoroethylene (PTFE).

As the aqueous binder contained in the negative composite layer, a copolymer containing, as monomers, two or more of the components described above, can also be used. Examples of such a copolymer include an ethylene-propylene copolymer, an ethylene-methacrylic acid copolymer, an ethylene-acrylic acid copolymer, a propylene-butene copolymer, an acrylonitrile-styrene copolymer, a methylmethacrylate-butadiene-styrene copolymer and the like. These copolymers can be preferably used in a state of being dispersed in water as a binder. That is, examples of the aqueous binder which can be used include a water-dispersed matter of the ethylene-propylene copolymer, a water-dispersed matter of the ethylene-methacrylic acid copolymer, a water-dispersed matter of the ethylene-acrylic acid copolymer, a water-dispersed matter of the propylene-butene copolymer, a water-dispersed matter of the acrylonitrile-styrene copolymer, a water-dispersed matter of the methylmethacrylate-butadiene-styrene copolymer and the like.

A glass-transition temperature (T_{g}) of the aqueous binder contained in the negative composite layer, is not particularly limited; however, it is preferred when the glass-transition temperature (T_{g}) is −30° C. or higher and 50° C. or lower since the problem-free adhesion and flexibility can be achieved simultaneously during producing a plate and processing a plate.

Further, the negative composite layer can include a thickner. Examples of the thickner include starch-based polymers, alginic acid-based polymers, microorganism-based polymers and cellulose-based polymers.

The cellulose-based polymers can be classified into nonionic polymers, cationic polymers and anionic polymers. Examples of the nonionic cellulose-based polymers include alkyl cellulose, hydroxyalkyl cellulose and the like. Examples of the cationic cellulose-based polymers include chlorinated o-[2-hydroxy-3-(trimethylammonio)propyl]hydroxyethyl cellulose (polyquaternium-10) and the like. Examples of the anionic cellulose-based polymers include alkyl celluloses having a structure represented by the following general formula (1) or general formula (2) formed by substituting the nonionic cellulose-based polymers with various derivative groups, and metallic salts or ammonium salts thereof.

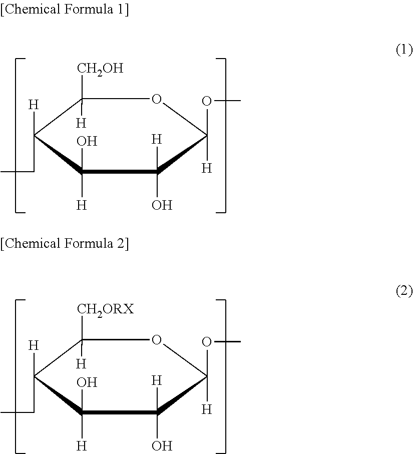

In the above general formula (1) and general formula (2), n is a natural number. In the above general formula (2), X is preferably an alkali metal, NH4 or H. R is preferably a divalent hydrocarbon group. The number of carbon atoms of the hydrocarbon group is not particularly limited; however, it is usually about 1 to 5. Further, R may be a hydrocarbon group or an alkylene group which contains a carboxy group.

Specific examples of the anionic cellulose-based polymers include carboxymethyl cellulose (CMC), methyl cellulose (MC), hydroxypropyl methyl cellulose (HPMC), sodium cellulose sulfate, methyl ethyl cellulose, ethyl cellulose and salts thereof. Among these celluloses, carboxymethyl cellulose (CMC), methyl cellulose (MC), and hydroxypropyl methyl cellulose (HPMC) are preferred, and carboxymethyl cellulose (CMC) is more preferred.

A degree of substitution of a substitute such as a carboxymethyl group for hydroxy groups (three groups) per anhydroglucose unit in the cellulose, is referred to as a degree of etherification, and the degree of etherification can theoretically assume a value of 0 to 3. A smaller etherification degree shows that the hydroxy group in the cellulose increases and the substitute decreases. In the present invention, a degree of etherification of cellulose as the thickner contained in the negative composite layer is not particularly limited; however, the degree of etherification is preferably 1.5 or less, more preferably 1 or less, furthermore preferably 0.8 or less, and moreover preferably 0.6 or less.

In addition, the negative composite layer may contain other components such as a dispersing agent like a surfactant in addition to the amorphous carbon as the negative active material and the aqueous binder as the binder.

The content of the amorphous carbon in the negative composite layer is preferably 50% by mass or more with respect to a mass of the negative composite layer from the viewpoint of more improving a battery capacity. Further, the content of the amorphous carbon is more preferably 60% by mass or more, furthermore preferably 70% by mass or more, furthermore preferably 80% by mass or more, and moreover preferably 90% by mass or more with respect to a mass of the negative composite layer.

A porosity of the negative composite layer is not particularly limited, and it is preferably 50% or less, more preferably 45% or less, furthermore preferably 40% or less, and moreover preferably 35% or less. Further, the porosity of the negative composite layer is preferably 10% or more, more preferably 15% or more, furthermore preferably 20% or more, and moreover preferably 25% or more.

The positive electrode 3 includes a positive current collector and a positive composite layer formed on the positive current collector. The positive composite layer can contain a positive active material, a conduction aid, and a binder. The positive composite layer can be formed by applying a positive composite (positive electrode paste) prepared by mixing these materials using, for example, a proper solvent appropriate to properties of the binder to the positive current collector, and drying the composite. In so doing, a thickness or a porosity of the layer can be adjusted by roll pressing.

The positive current collector is configured by using a conducting material. The positive current collector can be formed by using a metal material such as aluminum, copper, nickel, stainless steel, titanium, or tantalum. Further, as a shape of the negative current collector, various shapes such as a sheet (foil or thin film), a plate, a columnar body, a coil, a foam, a porous body and an expanded grid, can be employed.

The positive active material is not limited with limits of capability of reversibly absorbing/releasing lithium ions. As such a positive active material, for example, a lithium transition metal composite oxide capable of absorbing/releasing lithium ions can be used. Examples of the lithium transition metal composite oxide include lithium-cobalt composite oxide such as LiCoO₂; lithium-nickel composite oxide such as LNiO₂; and lithium-manganese composite oxide such as LiMnO₂, LiMn₂O₄ and Li₂MnO₃. Further, a part of these transition metal atoms may be replaced with another transition metal or light metal. Or, olivine compounds capable of absorbing/releasing lithium ions may be used as the positive active material. Examples of the olivine compounds include olivine type lithium phosphate compounds such as LiFePO₄.

The conduction aid is a material to be added for the purpose of improving electrical conductivity of the positive composite, as required. As such a conduction aid, various conducting materials can be used, and the same materials as in the conduction aid described above can be employed.

The binder (positive electrode binder) is a material to be added for the purpose of binding the positive active materials together. Further, the binder also plays a role of binding the positive active material, the conduction aid and the positive current collector together. As the binder contained in the positive composite layer, the aqueous binder can be used, or the solvent type binder can also be used. As the aqueous binder, the same materials as in the above aqueous binder contained in the negative composite layer, can be employed.

The solvent type binder is a binder for which an organic solvent is used when being mixed with an active material or the like to form a paste. As the solvent type binder, polyvinylidene fluoride (PVdF), polymethyl methacrylate (PMMA), polyacrylonitrile (PAN) or the like can be used. When the solvent type binders are used, they can be preferably used in a state of being dissolved in an aprotic polar solvent which is one example of the organic solvent. As the aprotic polar solvent, aprotic amide-based solvents such as N-methyl-2-pyrrolidone (NMP) and N,N-dimethylformamide (DMF) can be used.

In addition, the positive composite layer may contain other components such as a thickner and a dispersant as with the negative composite layer.

The separator 5 separates the positive electrode 3 from the negative electrode 4 and retains a nonaqueous electrolyte, and is disposed between the positive electrode 3 and the negative electrode 4. As a material of the separator, various materials can be appropriately used, and for example, synthetic resin microporous membranes, cloths, nonwoven fabrics or the like can be used. As the synthetic resin microporous membranes, for example, a microporous membrane made of polyethylene, a microporous membrane made of polypropylene, or a combined microporous membrane thereof can be used.

In the nonaqueous electrolyte secondary battery of the present invention, an insulating layer may be disposed besides the separator between the positive electrode and the negative electrode. When the insulating layer is disposed besides the separator between the positive electrode and the negative electrode, it is possible to prevent the positive electrode and the negative electrode from electrically connecting to each other even though a usage pattern of the nonaqueous electrolyte secondary battery is out of a scope of the usage pattern usually foreseen. This is because, even when a thermal shrinkage of a separator causes owing to an abnormal heat which derives from being out of the scope of the usage pattern usually foreseen, the insulating layer remains.

The insulating layer can be an insulating porous layer, and for example, a porous layer containing an inorganic oxide, a porous layer containing resin beads, a porous layer containing a heat-resistant resin such as an aramid resin can be employed. In the nonaqueous electrolyte secondary battery of the present invention, the insulating layer is preferably the porous layer containing an inorganic oxide. The porous layer containing an inorganic oxide as the insulating layer may contain the binder and the thickner as required.

The binder and the thickner contained in the porous layer are not particularly limited, and for example, the same materials as those used in the composite layer (positive composite layer or negative composite layer) can be used.

As an inorganic oxide, publicly known ones can be used; however, the inorganic oxides having excellent chemical stability are preferred. Examples of such inorganic oxides include alumina, titania, zirconia, magnesia, silica, boehmite and the like. As the inorganic oxide, a powdery one is preferably used. The average particle size of the inorganic oxide is not particularly limited, and it is preferably 10 μm or less, more preferably 8 μm or less, furthermore preferably 5 μm or less, and moreover preferably 3 μm or less. Further, the average particle size of the inorganic oxide is not particularly limited, and it is preferably 0.01 μm or more, more preferably 0.05 μm or more, and moreover preferably 0.1 μm or more. The inorganic oxide may be used singly or may be used in combination of two or more types.

The insulating layer can be formed on one or more of one surface of the separator, both surfaces of the separator, a surface of the positive composite layer and a surface of the negative composite layer. Further, when the insulating layer is formed on the surface of the composite layer, at least a part of the composite layer may be covered with the insulating layer, or the whole area of the composite layer may be covered with the insulating layer.

As a method of forming the insulating layer, a publicly known method can be employed. For example, a method in which a composite for forming an insulating layer containing an inorganic oxide and a binder is applied to one or more of one surface of the separator, both surfaces of the separator, a surface of the positive composite layer and a surface of the negative composite layer, and dried, can be employed.

When the inorganic oxide and the binder are contained in the composite for forming an insulating layer, the content of the binder is not particularly limited; however, the content is preferably 20% by mass or less, and more preferably 10% by mass or less with respect to a mass of the insulating layer. Further, the content of the binder is preferably 1% by mass or more, and more preferably 2% by mass or more with respect to a total amount of the inorganic oxide and the binder. By satisfying such a content range, a good balance between mechanical strength and lithium ion conductivity of the insulating layer can be achieved.

A thickness of the insulating layer is not particularly limited, and it is preferably 20 μm or less, and more preferably 15 μm or less. The thickness of the insulating layer is preferably 2 μm or more, and more preferably 4 μm or more.

The form in which the insulating layer is formed on the surface (one surface or both surfaces) of the separator is more preferred than the form in which the insulating layer is formed on the surface of the composite layer (positive composite layer or negative composite layer). This is because, in the former, it does not happen that a layer in which the composite layer and the insulating layer are mixed with each other is formed at an interface between the composite layer and the insulating layer, and therefore a conductive path in the composite layer is kept good.

The form in which the insulating layer is formed on a surface facing the positive electrode of the surfaces of the separator is more preferred than the form in which the insulating layer is formed on a surface facing the negative electrode of the surfaces of the separator since it is possible to prevent the separator from being formed into polyene.

A power generating element 2 formed by including a positive electrode 3, a negative electrode 4, and a separator 5 is housed in a battery case 6. Further, the battery case 6 accommodates a nonaqueous electrolyte, and the power generating element 2 is impregnated with the nonaqueous electrolyte.

The nonaqueous electrolyte is obtained by dissolving a supporting salt in a nonaqueous solvent (solvent other than water). As the nonaqueous solvent, an organic solvent can be preferably used. As such an organic solvent, for example, carbonates such as dimethyl carbonate (DMC), ethylene carbonate (EC), diethyl carbonate (DEC), propylene carbonate (PC), butylene carbonate (BC) and ethyl methyl carbonate (EMC); esters such as γ-butyrolactone and methyl formate; and ethers such as 1,2-dimethoxyethane and tetrahydrofuran, can be suitably employed. A mixed solvent of two or more thereof may be employed.

As the nonaqueous solvent, a molten salt (ionic liquid) may be used. As such a molten salt, for example, imidazolium salts such as ethylmethylimidazoliumtetrafluoro borate (EMI-BF₄) and ethylmethylimidazoliumtrifluoromethane sulfonylimide (EMI-TESI); pyridinium salts such as 1-ethylpyridinium tetrafluoroborate and 1-ethylpyridinium trifluoromethanesulfonylimide; ammonium salts such as trimethyl propyl ammonium bis(trifluoromethanesulfonyl)imide (TMPA-TFSI); and sulfonium salts such as triethylsulfonium bis(trifluoromethanesulfonyl)imide (TES-TFSI), can be used.

As the supporting salt, a lithium salt can be used. As the lithium salt, any of inorganic lithium salts and organic lithium salts may be used. Examples of the inorganic lithium salts include lithium fluoride salts such as LiPF₆, LiAsF₆, LiBF₄ and LiSbF₆; lithium chloride salts such as LiAlCl₄; and lithium perhalogenates such as LiClO₄, LiBrO₄ and LiIO₄. Examples of the organic lithium salts include fluorine-containing organolithium salts. Examples of the fluorine-containing organolithium salts include perfluoroalkane sulfonic acid salts such as LiCF₃SO₃ and LiC₄F₉SO₃; perfluoroalkane carboxylic acid salts such as LiCF₃CO₂; perfluoroalkane carbonimido salts such as LiN(CF₃CO)₂; and perfluoroalkane sulfonimido salts such as LiN(CF₃SO₂)₂ and LiN(C₂F₅SO₂)₂. These may be used in combination of two or more thereof.

In addition, vinylene carbonate (VC) or the like may be added to the nonaqueous electrolyte as an additive.

The battery case 6 is configured using a metal material, for example, aluminum or an aluminum alloy. A battery lid 7 is fixed to an opening of the battery case 6 and seals the battery case 6 in a state in which the power generating element 2 and the nonaqueous electrolyte are housed in the battery case 6.

In the present embodiment, the battery lid 7 doubles as a positive electrode terminal. Further, a negative electrode terminal 9 is provided at a central part of the battery lid 7. The negative electrode 4 is connected to the negative electrode terminal 9 with a negative electrode lead 11 interposed. The positive electrode 3 is connected to the battery lid 7 as the positive electrode terminal with a positive electrode lead 10 interposed. In addition, a safety valve 8 for releasing a gas externally when an internal pressure in a sealed container reaches a predetermined pressure is disposed at the battery lid 7.

In the nonaqueous electrolyte secondary battery 1 as described above, the present invention is characterized by combining the negative electrode including an aqueous binder as a binder with the amorphous carbon having an average particle size of 7 μm or less as a negative active material.

Thereby, both of power characteristics and a capacity retention ratio can be improved. This point will be described in more detail below by way of examples and comparative examples. However, the present invention is not limited to these examples.

### EXAMPLES

### Example 1

The nonaqueous electrolyte secondary battery 1 of the embodiment shown in FIG. 1 was prepared by the following procedure.

### <1> Preparation of Negative Electrode

As a negative active material, amorphous carbon in which an average particle size was 5.5 μm and an interlayer distance d₀₀₂, determined by a wide angle X-ray diffraction method, was 3.45 Å, was prepared. The amorphous carbon (95.3 parts by mass), 2.8 parts by mass of a styrene-butadiene rubber (SBR) as a binder, 1.9 parts by mass of carboxymethyl cellulose (CMC) as a thickner, and water were mixed to prepare a negative composite (negative electrode paste). Next, the prepared negative composite was applied to both surfaces of a negative current collector made of a copper foil having a thickness of 10 μm by a doctor blade method to form a negative composite layer on the negative current collector. Thereafter, the negative composite layer was dried to obtain a negative electrode. A negative electrode lead was attached to the negative electrode.

### <2> Preparation of Positive Electrode

A LiFePO₄ powder (88 parts by mass) as a positive active material, 6 parts by mass of acetylene black as a conduction aid, 6 parts by mass of polyvinylidene fluoride (PVdF) as a binder, and N-methyl-2-pyrrolidone (NMP) were mixed to prepare a positive composite (positive electrode paste). Next, the prepared positive composite was applied to both surfaces of a positive current collector made of an aluminum foil having a thickness of 20 μm by a doctor blade method to form a positive composite layer on the positive current collector. Thereafter, the positive composite layer was dried to obtain a positive electrode. A positive electrode lead was attached to the positive electrode.

### <3> Preparation of Nonaqueous Electrolyte Secondary Battery

A polyethylene microporous membrane was used as a separator. A nonaqueous electrolyte solution as a nonaqueous electrolyte was prepared by dissolving LiPF₆ as a supporting salt, so as to have the concentration of 1 mol/l, in a mixed solvent in which a volume ratio of ethylene carbonate (EC)/dimethyl carbonate (DMC)/ethyl methyl carbonate (EMC) was 30:20:50. Then, a negative electrode and a positive electrode were wound with a separator interposed to form a power generating element, and the power generating element was housed in a prismatic battery case made of aluminum. Thereafter, a negative electrode was connected to a negative electrode terminal with a negative electrode lead interposed, a positive electrode was connected to a battery lid with a positive electrode lead interposed, and further the battery lid was attached to the battery case by laser welding. Thereafter, a nonaqueous electrolyte was injected under a reduced pressure, and an electrolyte solution filling hole was sealed by laser welding. Thereby, a prismatic nonaqueous electrolyte secondary battery having a nominal capacity of 400 mAh (this is referred to as a battery A) was prepared.

### Example 2

A battery B was prepared in the same manner as in Example 1 except for using amorphous carbon having an average particle size of 7.0 μm as a negative active material in the battery A of Example 1.

### Comparative Example 1

A battery C was prepared in the same manner as in Example 1 except for using amorphous carbon having an average particle size of 11.5 μm as a negative active material in the battery A of Example 1.

### Comparative Example 2

A battery D was prepared in the same manner as in Example 1 except for using amorphous carbon having an average particle size of 14.5 μm as a negative active material in the battery A of Example 1.

### Comparative Example 3

A battery E was prepared in the same manner as in Example 1 except for using amorphous carbon having an average particle size of 16.8 μm as a negative active material in the battery A of Example 1.

### Example 3

A negative electrode of a battery of Example 3 was prepared in the same manner as in Example 1 except that in the negative electrode of the battery A of Example 1, amorphous carbon in which an average particle size was 2.3 μm and an interlayer distance d₀₀₂, determined by a wide angle X-ray diffraction method, was 3.70 Å, was used as a negative active material, and the amounts of the amorphous carbon, the styrene-butadiene rubber (SBR) as a binder and the carboxymethyl cellulose (CMC) as a thickner were changed to 97 parts by mass, 2 parts by mass and 1 part by mass, respectively.

A positive electrode of a battery of Example 3 was prepared in the same manner as in Example 1 except that in the positive electrode of the battery A of Example 1, 88 parts by mass of LiNi_{0.33}Co_{0.33}Mn_{0.33}O₂ was used as a positive active material, 6 parts by mass of acetylene black as a conduction aid and 6 parts by mass of polyvinylidene fluoride (PVdF) were used.

A nonaqueous electrolyte of a battery of Example 3 was prepared in the same manner as in Example 1 except that in the nonaqueous electrolyte of the battery A of Example 1, a nonaqueous solvent is a mixed solvent in which a volume ratio of ethylene carbonate (EC)/dimethyl carbonate (DMC)/ethyl methyl carbonate (EMC) was 30:20:50, and LiPF₆ was dissolved in the nonaqueous solvent as a supporting salt so as to have the concentration of 1 mol/l.

A battery F was prepared in the same manner as in Example 1 except that in the battery A of Example 1, the negative electrode, the positive electrode and the nonaqueous electrolyte were configured as described above, and a nominal capacity was changed to 5.0 Ah.

### Example 41

A battery G was prepared in the same manner as in Example 3 except for using amorphous carbon having an average particle size of 3.1 μm as a negative active material in the battery F of Example 3.

### Example 5

A battery H was prepared in the same manner as in Example 3 except for using amorphous carbon having an average particle size of 4.2 μm as a negative active material in the battery F of Example 3.

### Comparative Example 4

A battery I was prepared in the same manner as in Example 3 except for using amorphous carbon having an average particle size of 9.8 μm as a negative active material in the battery F of Example 3.

### [Evaluation Test]

### 1. Examples 1 to 2 and Comparative Examples 1 to 3 (Batteries A to E)

### (1-1) Verification Test of Initial Capacity

In each of the batteries A to E of Examples 1 to 2 and Comparative Examples 1 to 3, the verification test of an initial capacity was performed in the following charge-discharge conditions. The battery was charged at a constant current of 400 mA at 25° C. to 3.55 V, and further charged at a constant voltage of 3.55 V to perform charge for 3 hours in all including constant current charge and constant voltage charge. After charging, the battery was discharged at a constant current of 400 mA to an end-of-discharge voltage of 2.00 V, and this discharge capacity was defined as an “initial capacity”.

(1-2) Calculation of Capacity Retention Ratio (after 500 Cycle Test)

On each of the batteries A to E after the verification test of an initial capacity, a cycle life test was performed in the following conditions. A series of operations in which a battery was charged at a constant current of 400 mA at 45° C. to 3.55 V, further charged at a constant voltage of 3.55 V to perform charge for 3 hours in all including constant current charge and constant voltage charge, and then discharged at a constant current of 400 mA to 2.00 V, was taken as 1 cycle, and this cycle was repeated 500 times.

Then, on each of the batteries A to E after 500 cycles, a discharge capacity was measured in the same conditions as in the verification test of an initial capacity, and a capacity retention ratio was calculated by dividing the discharge capacity by the initial capacity.

### (1-3) Calculation of Relative Value of Direct-Current Resistance (Rx)

An SOC (state of charge) of a battery was set to 50% by charging each of the batteries A to E after the verification test of an initial capacity at a constant current of 400 mA at 25° C. to 3.20 V, and further charging at a constant voltage of 3.20 V for 3 hours in all, and the battery was held at 0° C. for 5 hours. Thereafter, a voltage (E1) at the time of discharging the battery at 80 mA (I1) for 10 seconds, a voltage (E2) at the time of discharging the battery at 200 mA (I2) for 10 seconds and a voltage (E3) at the time of discharging the battery at 400 mA (I3) for 10 seconds were measured. Herein, “SOC is 50%” represents that an amount of charge is 50% with respect to the capacity of a battery.

A direct-current resistance (Rx) was calculated using the above-mentioned measurements (E1, E2, E3). Specifically, the measurements (E1, E2, E3) were plotted on a graph in which a horizontal axis was a current and a vertical axis was a voltage, these three measurement points were approximated by a regression line (approximation line) based on a least square method, and a slope of the line was taken as a direct-current resistance (Rx).

Direct-current resistances (Rx) of the batteries A to E (Examples 1, 2 and Comparative Examples 1 to 3) were relatively compared with one another based on the direct-current resistance (Rx) obtained in the battery E (Comparative Example 3). That is, a relative value of the direct-current resistance (Rx) of each of the batteries A to E to the direct-current resistance (Rx) of the battery E was calculated from the following formula (1). The direct-current resistance (Rx) of the battery E was 816.4 mΩ.

Relative value of direct-current resistance (Rx) of each of batteries A to E=[Direct-current resistance (Rx) of each of batteries A to E/Direct-current resistance (Rx) of battery E]×100 (1)

The capacity retention ratios (after 500 cycle test) and the relative values to the direct-current resistance (Rx) of the battery E of the batteries A to E thus calculated are shown in Table 1.

TABLE 1

| | | Average | Capacity | |
|---|---|---|---|---|
| | | Particle | Retention | |
| | | Size of | Ratio/% | Relative Value of |
| | | Amorphous | (after | Direct-Current |
| | Battery | Carbon/μm | 500 Cycles) | Resistance (Rx)/% |
| Example 1 | A | 5.5 | 86.2 | 73.0 |
| Example 2 | B | 7.0 | 85.2 | 80.0 |
| Comparative | C | 11.5 | 67.1 | 104.9 |
| Example 1 | | | | |
| Comparative | D | 14.5 | 60.3 | 114.4 |
| Example 2 | | | | |
| Comparative | E | 16.8 | 77.5 | 100.0 |
| Example 3 | | | | |

### 2. Examples 3 to 5 and Comparative Example 4 (Batteries F to I)

### (2-1) Verification Test of Initial Capacity

In each of the batteries F to I of Examples 3 to 5 and Comparative Example 4, the verification test of an initial capacity was performed in the following charge-discharge conditions. The battery was charged at a constant current of 5.0 A at 25° C. to 4.20 V, and further charged at a constant voltage of 4.20 V to perform charge for 3 hours in all including constant current charge and constant voltage charge. After charging, the battery was discharged at a constant current of 5.0 A to an end-of-discharge voltage of 2.50 V, and this discharge capacity was defined as an “initial capacity”.

(2-2) Calculation of Capacity Retention Ratio (after being Left Standing in a High-Temperature Environment)

On each of the batteries F to I after the verification test of an initial capacity, an SOC of a battery was adjusted to 90% by charging the battery by 90% of the initial capacity, and then the battery was stored for 60 days in an environment of 65° C. On each of the batteries F to I after storing for 60 days, a discharge capacity was measured in the same conditions as in the measurement of an initial capacity, and a capacity retention ratio was calculated by dividing the discharge capacity by the initial capacity.

### (2-3) Calculation of Relative Value of Direct-Current Resistance (Ry)

On each of the batteries F to I after the verification test of an initial capacity, an SOC of a battery was adjusted to 50% by charging the battery by 50% of the initial capacity, and the battery was held at −10° C. for 4 hours. Thereafter, a voltage (E4) at the time of discharging the battery at 1.0 A (I4) for 10 seconds, a voltage (E5) at the time of discharging the battery at 2.5 A (I5) for 10 seconds and a voltage (E6) at the time of discharging the battery at 5.0 A (E6) for 10 seconds were measured. A direct-current resistance (Ry) was calculated using these measurements (E4, E5, E6). Specifically, the measurements (E4, E5, E6) were plotted on a graph in which a horizontal axis was a current and a vertical axis was a voltage, these three measurement points were approximated by a regression line (approximation line) based on a least square method, and a slope of the line was taken as a direct-current resistance (Ry).

Direct-current resistances (Ry) of the batteries F to I (Examples 3 to 5 and Comparative Example 4) were relatively compared with one another based on the direct-current resistance (Ry) obtained in the battery I (Comparative Example 4). That is, a relative value of the direct-current resistance (Ry) of each of the batteries F to I to the direct-current resistance (Ry) of the battery I was calculated from the following formula (2).

Relative value of direct-current resistance (Ry) of each of batteries F to I=[Direct-current resistance (Ry) of each of batteries F to I/Direct-current resistance (Ry) of battery I]×100 (2)

The capacity retention ratios (after being left standing in a high-temperature environment) and the relative values to the direct-current resistance (Ry) of the battery I of the batteries F to I thus calculated are shown in Table 2.

TABLE 2

| | | | Capacity Retention | Relative |
|---|---|---|---|---|
| | | Average | Ratio/% (after | Value of |
| | | Particle | being left | Direct- |
| | | Size of | standing under a | Current |
| | | Amorphous | high-temperature | Resistance |
| | Battery | Carbon/μm | environment) | (Ry)/% |
| Example 3 | F | 2.3 | 82.7 | 64.8 |
| Example 4 | G | 3.1 | 86.5 | 73.8 |
| Example 5 | H | 4.2 | 85.8 | 83.4 |
| Comparative | I | 9.8 | 79.8 | 100.0 |
| Example 4 | | | | |

### [Consideration]

The following matters became apparent from the results shown in Table 1.

In the battery A (Example 1) and the battery B (Example 2) in which the average particle sizes of the amorphous carbon as the negative active material were 7 μm or less, relative values of the direct-current resistances (Rx) to the direct-current resistance (Rx) of the battery E were 80% or less, and the capacity retention ratios (after 500 cycles) were 85% or more. In the batteries C to E (Comparative Examples 1 to 3) in which the average particle sizes of the amorphous carbon as the negative active material were larger than 7 μm, relative values of the direct-current resistances (Rx) to the direct-current resistance (Rx) of the battery E were 100% or more, and the capacity retention ratios (after 500 cycles) were 80% or less. In the batteries A to E (Examples 1, 2 and Comparative Examples 1 to 3), it was found that relative values of the direct-current resistances (Rx) of the batteries A and B (Examples 1 and 2), in which the average particle size of the amorphous carbon is small, to the direct-current resistance (Rx) of the battery E, are smaller than those of the batteries C to E (Comparative Examples 1 to 3), and power characteristics tend to increase. Further, in the batteries A to E (Examples 1, 2 and Comparative Examples 1 to 3), when the average particle size of the amorphous carbon is reduced, the capacity retention ratio turned from decrease to increase at the average particle size (14.5 μm) of the amorphous carbon corresponding to the battery D (Comparative Example 2) as a boundary. The reason for this is supposed that the average particle size of the amorphous carbon as a boundary at which the capacity retention ratio turns from decrease to increase with a reduction of the average particle size of the amorphous carbon, exists between the average particle size (16.8 μm) of the amorphous carbon corresponding to the battery E (Comparative Example 3) and the average particle size (11.5 μm) of the amorphous carbon corresponding to the battery C (Comparative Example 1).

Although a factor that the capacity retention ratio turns from decrease to increase with a reduction of the average particle size of the amorphous carbon is not clear, it is thought as the factor that the aqueous binder strongly interacts with the surface of the amorphous carbon particle. Since the amorphous carbon is fired and produced at a temperature lower than other carbon materials, it is thought that a large amount of a surface functional group (including hydrophilic groups such as a hydroxy group (—OH) and an oxo group (═O)) remains, and the aqueous binder strongly interacts with the surface of the amorphous carbon resulting from the surface functional group. That is, it is thought that the aqueous binder more strongly interacts with the surface of the amorphous carbon since the amount of the surface functional group is increased by reducing the average particle size of the amorphous carbon to 7 μm or less. Thereby, the activity of the particle surface of the amorphous carbon is lowered to suppress a decomposition reaction of the nonaqueous electrolyte at the particle surface of the amorphous carbon to increase the capacity retention ratio.

Further, when the cellulose-based polymers (e.g., alkyl cellulose and salts thereof) are used as the thickner contained in the negative composite layer, the thickner is thought to interact with the surfaces of the amorphous carbon particles since the thickner includes substitutes such as a hydroxy group and a carboxymethyl group. That is, since the negative composite layer includes the thickner, it is thought that the activity of the surface of the amorphous carbon particle is further lowered.

The cellulose-based polymers are not particularly limited; and they preferably include carboxymethyl cellulose (CMC). Further, a degree of etherification of the cellulose-based polymer is not particularly limited; however, it is preferably 1 or less since it is thought that the hydroxyl groups exist in large numbers to further lower the activity of the surface of the amorphous carbon particle.

The present inventors made investigations concerning a battery including a negative electrode using an aqueous binder, and the present inventors found that the capacity retention ratio of a battery is improved contrary to conventional technical common knowledge. The improvement is made by setting the average particle size of the amorphous carbon as the negative active material to a value smaller than the specific particle size presents between 11.5 μm and 16.8 μm. This cannot be easily conceived by even those skilled in the art.

Further, that the capacity retention ratio is improved by setting the average particle size of the amorphous carbon as the negative active material to a value smaller than the specific particle size between 11.5 μm and 16.8 μm is supposed to be an effect achieved based on containing the aqueous binder in the negative electrode.

The following matters became apparent from the results shown in Table 2.

In the batteries F to H (Examples 3 to 5) in which the negative electrode included amorphous carbon as a negative active material and an aqueous binder, and the average particle sizes of the amorphous carbon particles were 7 μm or less, specifically, the average particle sizes were set to 2.3 μm, 3.1 μm, and 4.2 μm, respectively, relative values of the direct-current resistances (Ry) to the direct-current resistance (Ry) of the battery I were 85% or less, and the capacity retention ratios (after being left standing in a high-temperature environment) were 80% or more. In the battery I (Comparative Example 4) in which the average particle size of the amorphous carbon as the negative active material was larger than 7 μm, the relative value of the direct-current resistance (Ry) to the direct-current resistance (Ry) of the battery I was 100%, and the capacity retention ratio (after being left standing in a high-temperature environment) was less than 80%. The reason why the batteries F to H (Examples 3 to 5) exhibit high capacity retention ratio and high power characteristics as with the batteries A and B (Examples 1 and 2) is supposed that as with above description, the negative electrode included amorphous carbon as a negative active material and an aqueous binder, and the average particle sizes of the amorphous carbon particles were set to 7 μm or less.

From these results, it was found that when the negative electrode includes amorphous carbon as a negative active material and an aqueous binder, and the average particle sizes of the amorphous carbon particles are set to 7 μm or less, the power characteristics and the capacity retention ratio can be improved.

The embodiments disclosed in the present specification and the examples which are implementation thereof are intended to illustrate the invention in all respects and are not to be construed to limit the invention. It will be readily understood that those skilled in the art can appropriately modify the above-mentioned embodiments and examples without departing from the gist of the invention. Accordingly, naturally, another embodiment modified without departing from the gist of the invention is embraced by the scope of the invention.

For example, the positive electrode material, the nonaqueous electrolyte and the like can be appropriately selected in accordance with performance/specification required of the nonaqueous electrolyte secondary battery.

Further, for example, as the aqueous binder contained in the negative electrode, various compounds having specified characteristics can be employed without being limited to the compounds exemplified in the present specification.

Further, for example, with respect to a shape of the nonaqueous electrolyte secondary battery, a cylindrical or a laminate-shaped nonaqueous electrolyte secondary battery can be used without being limited to a prismatic shape.

The present invention can realize an energy storage apparatus using an assembled battery formed by combining a plurality of the nonaqueous electrolyte secondary batteries of the present invention, and one embodiment thereof is shown in FIG. 2. The energy storage apparatus includes a plurality of energy storage units 20. Each energy storage unit 20 is composed of the assembled battery including a plurality of the nonaqueous electrolyte secondary batteries 1. An energy storage apparatus 30 can be installed as a power supply for automobiles such as electric automobiles (EV), hybrid automobiles (HEV) and plug-in hybrid automobiles (PHEV).

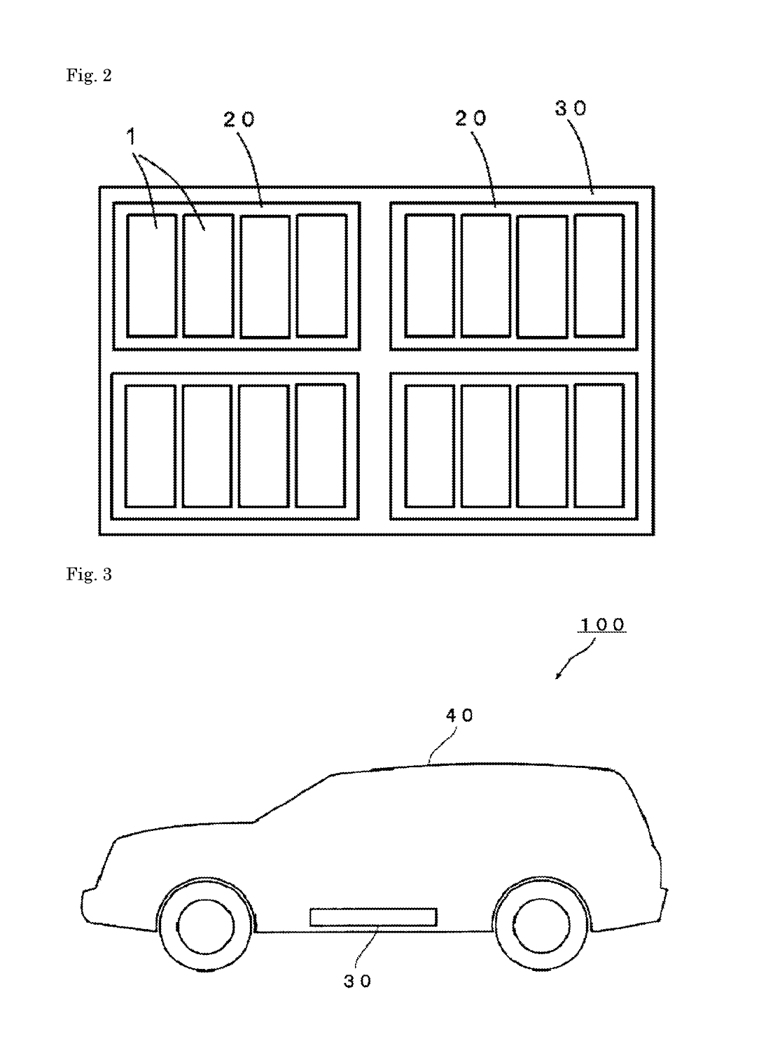

The energy storage apparatus 30 in which the nonaqueous electrolyte secondary battery of the present invention is used can be installed on an automobile 100 as a power supply for automobiles such as electric automobiles (EV), hybrid automobiles (HEV) and plug-in hybrid automobiles (PHEV), and one embodiment thereof is shown in FIG. 3. Further, since the nonaqueous electrolyte secondary battery of the present invention has high power characteristic, it is preferably used for an automobile power supply of hybrid automobiles (HEV) or an automobile power supply of plug-in hybrid automobiles (PHEV), and more preferably used for the automobile power supply of hybrid automobiles (HEV).

Further, for example, with respect to a subject which plays a role of electric conduction, cations of alkali metals such as sodium, potassium and cesium; cations of alkaline-earth metals such as calcium and barium; and cations of other metals such as magnesium, aluminum, silver and zinc, can be used without limiting to lithium ions. That is, another alkali metal ion secondary battery may be used.

### INDUSTRIAL APPLICABILITY

The present invention can be used for nonaqueous electrolyte secondary batteries such as a lithium ion secondary battery. Since the nonaqueous electrolyte secondary battery according to the present invention has excellent power characteristics and an excellent capacity retention ratio, it can be effectively used for a power supply for automobiles such as electric automobiles (EV), hybrid automobiles (HEV) and plug-in hybrid automobiles (PHEV), a power supply for electronic equipment, and a power supply for electric power storage.

### DESCRIPTION OF REFERENCE SIGNS

1 Nonaqueous electrolyte secondary battery
2 Power generating element
3 Positive electrode (positive electrode plate)
4 Negative electrode (negative electrode plate)
5 Separator
6 Battery case
7 Battery lid
8 Safety valve
9 Negative electrode terminal
10 Positive electrode lead
11 Negative electrode lead
20 Energy storage unit
30 Energy storage apparatus
40 Automobile main body
100 Automobile

1. A nonaqueous electrolyte secondary battery comprising:
a negative electrode including amorphous carbon as a negative active material and a binder,
wherein the binder contains an aqueous binder, and
wherein an average particle size of the amorphous carbon is 7 μm or less.

2. The nonaqueous electrolyte secondary battery according to claim 1, wherein the aqueous binder contains at least one selected from among rubber-like polymers and resin-based polymers which can be dissolved or dispersed in a water-based solvent.

3. The nonaqueous electrolyte secondary battery according to claim 1, wherein an interlayer distance d₀₀₂, which is determined by a wide angle X-ray diffraction method, of the amorphous carbon is 3.60 Å or more.

4. The nonaqueous electrolyte secondary battery according to claim 1,
wherein the negative electrode includes a thickner, and
wherein the thickner contains a cellulose-based polymer.

5. The nonaqueous electrolyte secondary battery according to claim 4, wherein the cellulose-based polymer includes a carboxymethyl cellulose.

6. The nonaqueous electrolyte secondary battery according to claim 4, wherein a degree of etherification of the cellulose-based polymer is 1 or less.

7. An assembled battery including a plurality of the nonaqueous electrolyte secondary batteries according to claim 1.

8. An energy storage apparatus including the assembled battery according to claim 7.

9. An automobile equipped with the energy storage apparatus according to claim 8.

10. A nonaqueous electrolyte secondary battery comprising:
a negative electrode including amorphous carbon as a negative active material and a binder,
wherein the binder contains an aqueous binder, and
wherein an average particle size of the amorphous carbon is 7 μm or less,
wherein the aqueous binder contains at least one selected from among rubber-like polymers and resin-based polymers which can be dissolved or dispersed in a water-based solvent, and
wherein an interlayer distance d₀₀₂, which is determined by a wide angle X-ray diffraction method, of the amorphous carbon is 3.60 Å or more.

11. The nonaqueous electrolyte secondary battery according to claim 10,
wherein the negative electrode includes a thickner, and
wherein the thickner contains a cellulose-based polymer.

12. The nonaqueous electrolyte secondary battery according to claim 11,
wherein the cellulose-based polymer includes a carboxymethyl cellulose.

13. The nonaqueous electrolyte secondary battery according to claim 11,
wherein a degree of etherification of the cellulose-based polymer is 1 or less.
